(19) United States
(12) Patent Application Publication
(10) Pub. No.: US 2024/0329881 A1
(43) Pub. Date: Oct. 3, 2024

(54) MANAGING DATA DESCRIPTOR READS DURING COMMAND PROCESSING IN A STORAGE DEVICE

(71) Applicant: WESTERN DIGITAL TECHNOLOGIES, INC., San Jose, CA (US)

(72) Inventors: VALLIVELRAJA PONNUDURAI, Bangalore (IN); RAM SAI PYDETI, Bangalore (IN); ROHAN JAYANT PALKAR, Bangalore (IN); KURUVA KRISHNA KISHORE, Bangalore (IN)

(73) Assignee: WESTERN DIGITAL TECHNOLOGIES, INC., San Jose, CA (US)

(21) Appl. No.: 18/233,970

(22) Filed: Aug. 15, 2023

Related U.S. Application Data
(60) Provisional application No. 63/456,617, filed on Apr. 3, 2023.

(51) Int. Cl. G06F 3/06

(52) U.S. Cl. CPC G06F 3/0659; G06F 3/0619; G06F 3/0679

(57) ABSTRACT

A storage device may manage data descriptor reads when processing a command received from a host. A host interface module on the storage device may receive a command to access data on a first memory device. The host interface module may generate one or more descriptors for the command. Each descriptor may include command information. A current descriptor for the command may be loaded in a second memory device and the host interface module may process the current descriptor. If the host interface module determines that the command information in the current descriptor is associated with a termination flag, the host interface module may prevent remaining descriptors associated with the command from being processed.

### CROSS-REFERENCE TO RELATED APPLICATION

The present application claims the benefit of U.S. Provisional Application Ser. No. 63/456,617 titled “MANAGING DATA DESCRIPTOR READS DURING COMMAND PROCESSING IN A STORAGE DEVICE,” filed Apr. 3, 2023, which is incorporated by reference herein in its entirety.

### BACKGROUND

A host may transmit a command to read data from and/or write data to, for example, a flash memory device coupled to a storage device. A host interface module on the storage device may interact with the host and when the storage device receives a command from the host, the host interface module may determine if the command is, for example, a write command, a read command, or an administration command. The host interface module may create an identification for the command (referred to herein as a command index).

A data transfer module on the storage device may check command attributes and depending on the configuration of the storage device, the data transfer module may process data associated with commands in blocks of, for example, 4K, 8K, or 16K bytes. The data transfer module may generate a descriptor for each block of data associated with a command. The data transfer module may also generate a descriptor index for each descriptor, wherein the descriptor index may point to a location in random-access memory (RAM) in the storage device where the associated descriptor is stored. The data transfer module may load the descriptors associated with a command in the RAM and a host interface adapter in the storage device may read the descriptors stored in the RAM to further process the command.

The data transfer module and the host interface adapter may exchange descriptor indexes in queues including, for example, an RX queue, a TX queue, or a completion queue. When the host interface adapter receives a descriptor index from a queue, it accesses the location in the RAM that the descriptor index points to determine the type of descriptor, the size of data, and other relevant information to execute a command associated with the descriptor.

When a command includes a large number of descriptors, the data transfer module may write all the descriptors associated with the command in the RAM, and the host interface adapter may read all the descriptors from the RAM, even if an error occurs when processing the command. Once all the descriptors are written to and read from the RAM, the host interface adapter may determine the command index for the command. If an error occurred while processing the command, after reading all the descriptors for the command from the RAM, the host interface adapter may update the error status of the command index.

Consider an example where a read command includes 512 descriptors. If an error occurs when the host interface adapter is reading the first descriptor of the read command, the data transfer module may perform 512 write operations and the host interface adapter may perform 512 read operations, for the host interface adapter to determine the command index for the read command and update the error status of the command index. In this example, after the host interface adapter encountered the error while reading the first descriptor, it would be a waste of system resources for the data transfer module to write the remaining descriptors for the read command to the RAM (i.e., perform 511 write operations) and for the host interface adapter to read the remaining descriptors from the RAM (i.e., perform 511 read operations).

### SUMMARY

In some implementations, a storage device is provided to manage data descriptor reads during command processing. The storage device is communicatively coupled to a host device that transmits commands to access data on the storage device. The storage device may include a first memory device to store data and a host interface module. The host interface module may receive, from the host device, a command to access data on the first memory device and generate one or more descriptors for the command, wherein the descriptors include command information.

The host interface module may execute the command by processing a current descriptor for the command in a second memory device on the storage device. If the host interface module determines that the command information in the current descriptor is associated with a termination flag, the host interface module may prevent the remaining descriptors associated with the command from being processed.

In some implementations, a method is presented to manage descriptor reads during command processing in the storage device. The method includes receiving, by the storage device from the host device, a command to access data on the first memory device and generating one or more descriptors for the command, wherein the descriptors include command information. The method also includes processing a current descriptor for the command in a second memory device on the storage device, determining when the command information in the current descriptor is associated with a termination flag, and preventing remaining descriptors associated with the command from being processed.

In some implementations, a storage device may manage descriptor reads during command processing and may include a host interface adapter to exchange information with the host device and receive a command from the host device to access data on the first memory device. The storage device may also include a data transfer module to generate one or more descriptors for the command and load a current descriptor for the command in a second memory device on the storage device, wherein the descriptors include command information. The host interface adapter may read and process the current descriptor in the second memory device and if the host interface adapter determines that the current descriptor is associated with a termination flag and the data transfer module may stop writing the remaining descriptors associated with the command in the second memory device.

### BRIEF DESCRIPTION OF THE SEVERAL VIEWS OF THE DRAWINGS

FIG. 1 is a schematic block diagram of an example system in accordance with some implementations.

FIGS. 2A and 2B are schematic block diagrams of example descriptor structures in accordance with some implementations.

FIG. 3 is a schematic block diagram of an example host interface module in accordance with some implementations.

FIG. 4 is a flow diagram of an example process for managing descriptor reads during command processing in a storage device in accordance with some implementations.

FIG. 5 is a diagram of an example environment in which systems and/or methods described herein are implemented.

FIG. 6 is a diagram of example components of the host of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

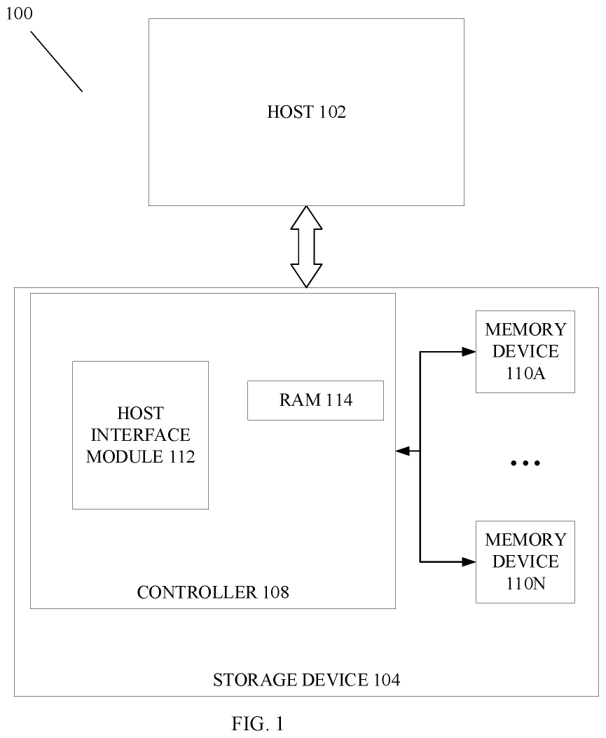

FIG. 1 is a schematic block diagram of an example system in accordance with some implementations. System 100 includes a host 102 and a storage device 104. Host 102 may transfer commands to read data from or write data to storage device 104. Host 102 and storage device 104 may be in the same physical location as components on a single computing device or on different computing devices that are communicatively coupled. Storage device 104, in various embodiments, may be disposed in one or more different locations relative to the host 102. System 100 may include additional components (not shown in this figure for the sake of simplicity).

Storage device 104 may include a controller 108 with a host interface module 112 and a random-access memory (RAM) 114. Storage device 104 may also include one or more memory devices 110a-110n (referred to herein as memory device(s) 110). Controller 108 may execute background operations to manage resources on memory devices 110. For example, controller 108 may monitor memory devices 110 and may execute garbage collection and other relocation functions per internal relocation algorithms to refresh and/or relocate the data on memory devices 110. Memory devices 110 may be, for example, non-volatile memory devices such as one or more flash memory and/or other persistent data storage. Memory devices 110 may be included in storage device 104 or may be otherwise communicatively coupled to storage device 104.

In some implementations, host interface module 112 and host 102 may be communicatively coupled via Universal Flash Storage (UFS) over Unipro standard, wherein host interface module 112 and host 102 may interface for command, data, and/or response handshakes. Host 102 may initiate commands to storage device 104 to, for example, read data from and/or write to memory device 110 and host 102 may complete the command after receiving a response from storage device 104.

When storage device 104 receives a command from host 102, host interface module 112 may determine if the command is, for example, a write command, a read command, or an administration command. If the command received from host 102 is a write command, storage device 104 may send a Read-to-Transfer (RTT) indication to host 102 for a portion of the data host 102 wants to write to memory device 110. Host 102 may transmit the data to be written to memory device 110 based on the RTT indication it receives from storage device 104. Storage device 104 may continue to send indications to host 102 for portions of the data to be written to memory device 110 and host 102 may continue to transmit data to storage device 104 based on the in RTT indications host 102 receives from storage device 104 until the complete data for the command is written to memory device 110. When storage device 104 writes the complete data for the command to memory device 110, storage device 104 may send a response to host 102.

If the command received from host 102 is a read command, storage device 104 may return portions of the data to host 102 until it reads the complete data from memory device 110. When storage device 104 reads the complete data for the command from memory device 110, storage device 104 may send a response to host 102.

When host interface module 112 receives a command to read data from or write data to memory device 110, host interface module 112 may generate descriptor(s) that are associated with the command. Consider an example where host interface module 112 receives a command to read 256 KB of data from memory device 110. Depending on the configuration, the host interface module 112 may read the data in 4 KB blocks and generate a descriptor for each block. As such, to read 256 KB of data from memory device 110, the host interface module 112 may generate sixty-four descriptors for the read command. When host interface module 112 completes a transaction, host interface module 112 may also generate descriptor(s) for the completed transaction.

Host interface module 112 may generate a descriptor index for each descriptor and a command index for each command. The command index may be information that identifies the command. Host interface module 112 may use the descriptor index associated with each descriptor to locate the descriptor in RAM 114 and thereby execute the command. Host interface module 112 may also retrieve the command index for the command from each descriptor. As such, host interface module 112 may not have to read all descriptors associated with a command to identify the command index for the command.

In some implementations, if host interface module 112 encounters an error while processing a current descriptor in RAM 114 that is associated with a command, host interface module 112 may identify the command index in the current descriptor being processed and generate an error/termination flag for the command index associated with that descriptor. Host interface module 112 may save the command index as an error command index in one or more error tables and may avoid writing the remaining descriptors associated with the command index into RAM 114, thereby improving the performance of storage device 104. As indicated above FIG. 1 is provided as an example. Other examples may differ from what is described in FIG. 1.

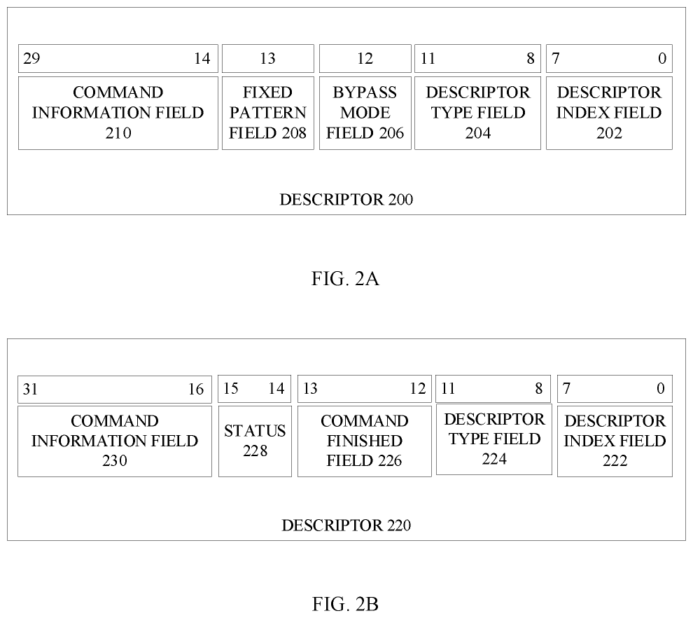

FIG. 2A is a schematic block diagram of an example descriptor structure in accordance with some implementations. The descriptor structure (referred to herein as descriptor 200) may include information in a TX/RX queue and may be associated with a read and/or write command and is. The top row in descriptor 200 indicates the bits in the memory used for the fields in the descriptor. Descriptor 200 may include a descriptor index field 202, a descriptor type field 204, a bypass mode field 206, a fixed pattern field 208, and a command information field 210. Descriptor index field 202 may identify a location in RAM 114 where an associated descriptor is stored. Descriptor type field 204 may describe the descriptor and may identify the size of the associated descriptor. For example, for descriptors in a TX queue, descriptor type field 204 may describe if the descriptor is an auto-transfer read descriptor, a manual-transfer read descriptor, or a fetch descriptor. For descriptors in an RX queue, descriptor type field 204 may describe if the descriptor is an auto-transfer write descriptor, manual-transfer write descriptor, hardware-completion descriptor, firmware-completion descriptor, flush-completion descriptor, or interrupt-request descriptor.

Bypass mode field 206 may be set to a normal mode or a bypass mode, wherein in the normal mode the descriptor may be executed according to values specified in the descriptor and in the bypass mode the operation of the descriptor may be bypassed without producing an error flag. Fixed pattern field 208 may indicate whether a descriptor is a fixed pattern. The command information field 210 may include the command index or other command information for the command associated with the descriptor. The command information may be any information that uniquely identifies the command.

FIG. 2B is a schematic block diagram of another example descriptor structure in accordance with some implementations. The descriptor structure (referred to herein as descriptor 220) may include information in a completion queue and may be associated with a completed command. The top row in descriptor 220 indicates the bits in the memory used for the fields in the descriptor. Descriptor 220 may include a descriptor index field 222, a descriptor type field 224, a command finished field 226, a status field 228, and a command information field 230. Descriptor index field 202 may identify a location in RAM 114 where an associated descriptor is stored. Descriptor type field 204 may describe the descriptor and may identify the size of the associated descriptor. Command finished field 226 may indicate whether a command is completed and if the descriptor includes buffers. Status field 228 may be set to a normal mode, a bypass mode, error, or abort, wherein in the normal mode the descriptor may be executed according to values specified in the descriptor, in the bypass mode the operation of the descriptor may be bypassed without producing an error flag, an error field may indicate that the descriptor is associated with an error command, and an abort field may indicate that the descriptor is associated with an abort command. Command information field 230 may include the command index or other command information for the command associated with the descriptor. The command information may be any information that uniquely identifies the command. FIGS. 2A and 2B are provided as examples. Other examples may differ from what is described in FIGS. 2A and 2B.

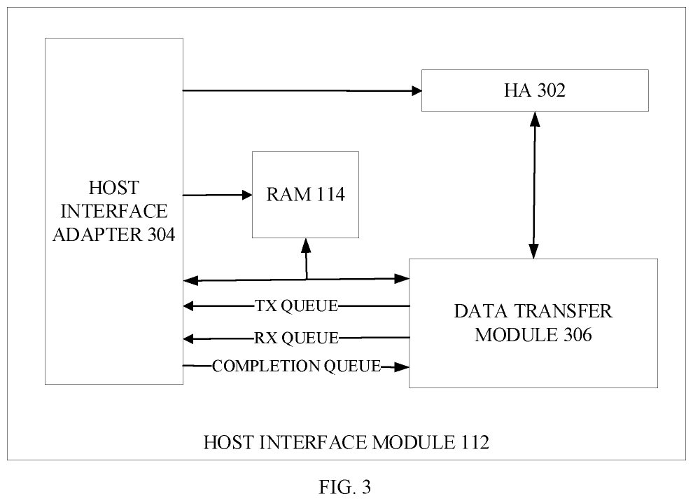

FIG. 3 is a schematic block diagram of an example host interface module in accordance with some implementations. Host interface module 112 may include one or more hardware accelerators (HA) 302 (also referred to herein as accelerator(s) 302), a host interface adapter (HIA) 304, and a data transfer module 306. Host interface adapter 304 may interact with host 102 to receive and/or transmit commands, data, and/or response handshakes. When host interface adapter 304 receives a command from host 102, host interface adapter 304 may perform a primary check of the command and create a command index for the command. Host interface adapter 304 may then send the command to accelerator 302, which may further process the command and forward the command to data transfer module 306. Data transfer module 306 may check, for example, the command type, the command length, and other attributes. Depending on the configuration of storage device 104, data transfer module 306 may process the data associated with commands received from host 102 in blocks of, for example, 4K, 8K, or 16K bytes. Data transfer module 306 may generate a descriptor for each block of data associated with a command, with each descriptor including a descriptor index and a command index.

Host interface adapter 304 may be communicatively coupled to data transfer module 306 to enable host interface module 112 to receive information from and/or transmit information to data transfer module 306 in queues. For example, data transfer module 106 may transmit descriptor indexes for write instructions in an RX queue and descriptor indexes for read instructions in a TX queue, and host interface adapter 302 may transmit descriptor indexes for completed transactions in a completion queue.

As a command is being processed, data transfer module 306 may write an associated descriptor in RAM 114 and trigger the appropriate TX/RX queue interface. The descriptor being written in RAM 114 is referred to herein as the current descriptor. Data transfer module 306 may include the descriptor index and/or command index for the current description in the TX/RX queue. Based on the descriptor index in TX/RX queue, host interface adapter 304 may read the current descriptor from RAM 114 and proceed to further process the command. In an example where the command includes 512 descriptors, data transfer module 306 may write the 512 descriptors to RAM 114, and host interface adapter 304 may read the 512 descriptors from RAM 114 to process the command.

In some cases, host interface adapter 304 may encounter an error while processing the command. Host interface module 112 may also receive an abort command from host 102 to abort processing the command. To improve the performance of storage device 104, host interface module 112 may reduce the number of write operations to RAM 114 by data transfer module 306 and the number of read operations from RAM 114 by host interface adapter 304, when host interface adapter 304 encounters an error or abort instruction. Host interface module 112 may encounter an error if, for example, there is a data path protection error in the command design, host 102 sends a wrong data format in response to an RTT indication, or there is a backend system error.

If host interface adapter 304 encounters an error or abort instructions while processing a command, host interface adapter 304 may not need to read the remaining descriptors associated with the command and may associate the command index for the command being processed with a termination flag. Host interface adapter 304 may send an error message in the completion queue to data transfer module 306. The error message may include the command index for the command. When data transfer module 306 receives the error message, data transfer module 306 may not load the remaining descriptors including the command index into RAM 114, thereby improving the device performance.

In some implementations, if an error message or abort message is received in the completion queue by data transfer module 306, it may send an indication to firmware on storage device 104. The firmware may send a firmware completion descriptor to host interface adapter 304 for completing the command. When host interface adapter 304 receives the firmware completion descriptor, host interface adapter 304 may clear the internal error flags for that command index and send an error response to host 102. If host interface adapter 304 receives the firmware completion descriptor for an abort command, host interface adapter 304 may send no response for the abort command. Host interface adapter 304 may send a completion indication to data transfer module 306. Host interface adapter 304 may use the same command index when it receives another command from host 102, as the command index is no longer associated with an error flag.

Consider an example, where host interface module 112 is processing a command with 512 descriptors. If an error occurs at the third descriptor (i.e., the third descriptor is the current descriptor loaded in RAM 114), host interface adapter 304 may obtain the command index from the third descriptor loaded in RAM 114. Host interface adapter 304 may flag the command index retrieved from the third descriptor as an error command index and store the error command index in an error command index table. Host interface adapter 304 may transmit an error message in the completion queue to data transfer module 306, wherein based on the error message, data transfer module 306 may not load the remaining 509 descriptors associated with the command index into RAM 114. Host interface module 112 may thus improve the performance of storage device 104 by aborting the reading and writing of the remaining descriptors associated with an error command index or an abort command.

Furthermore, if host interface adapter 304 receives a firmware completion descriptor from data transfer module 306, host interface adapter 304 may clear the internal error flags for the command index retrieved from the third descriptor and send an error response to host 102. When host interface module 112 receives another command from host 102, host interface module 112 may associate the other command with the command index retrieved from the third descriptor.

Storage device 104 may perform these processes based on a processor, for example, host interface module 112 executing software instructions stored by a non-transitory computer-readable medium, such as storage component 110. As used herein, the term “computer-readable medium” refers to a non-transitory memory device. Software instructions may be read into storage component 110 from another computer-readable medium or from another device. When executed, software instructions stored in storage component 110 may cause host interface module 112 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, storage device 104 may include additional components, fewer components, different components, or differently arranged components than those shown in FIG. 3. Additionally, or alternatively, a set of components (e.g., one or more components) of storage device 104 may perform one or more functions described as being performed by another set of components of storage device 104.

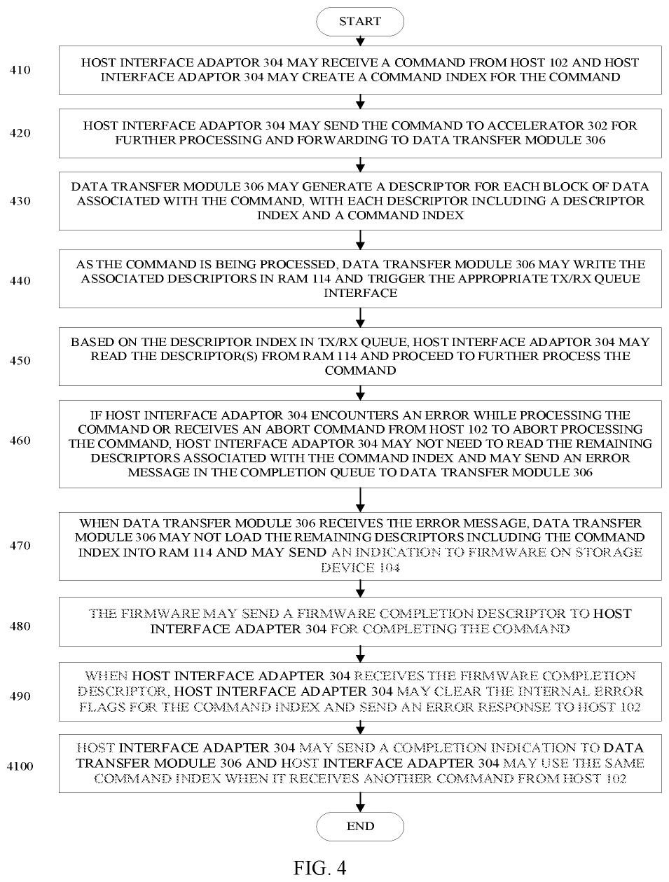

FIG. 4 is a flow diagram of an example process for managing descriptor reads during command processing in a storage device in accordance with some implementations. At 410, host interface adapter 304 may receive a command from host 102 and host interface adapter 304 may create a command index for the command. At 420, host interface adapter 304 may send the command to accelerator 302 for further processing and forwarding to data transfer module 306. At 430, data transfer module 306 may generate a descriptor for each block of data associated with the command, with each descriptor including a descriptor index and a command index.

At 440, as the command is being processed, data transfer module 306 may write the associated descriptors in RAM 114 and trigger the appropriate TX/RX queue interface. At 450, based on the descriptor index in TX/RX queue, host interface adapter 304 may read the descriptor(s) from RAM 114 and proceed to further process the command. At 460, if host interface adapter 304 encounters an error while processing the command or receives an abort command from host 102 to abort processing the command, host interface adapter 304 may not need to read the remaining descriptors associated with the command index and may send an error message in the completion queue to data transfer module 306. The error message may include the command index for the command. At 470, when data transfer module 306 receives the error message, data transfer module 306 may not load the remaining descriptors including the command index into RAM 114 and may send an indication to firmware on storage device 104. At 480, the firmware may send a firmware completion descriptor to host interface adapter 304 for completing the command. At 490, when host interface adapter 304 receives the firmware completion descriptor, host interface adapter 304 may clear the internal error flags for the command index and send an error response to host 102. At 4100, host interface adapter 304 may send a completion indication to data transfer module 306 and host interface adapter 304 may use the same command index when it receives another command from host 102. As indicated above FIG. 4 is provided as an example. Other examples may differ from what is described in FIG. 4.

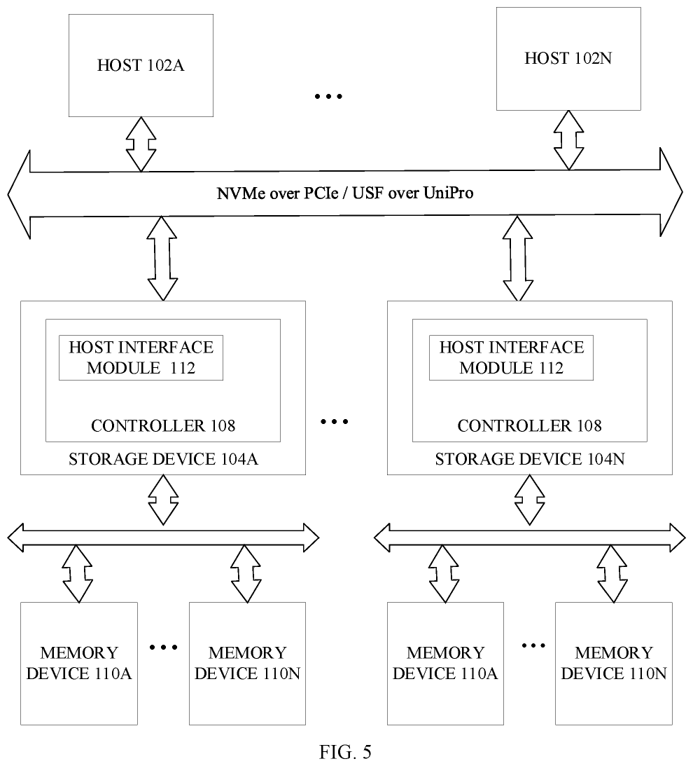

FIG. 5 is a diagram of an example environment in which systems and/or methods described herein are implemented. As shown in FIG. 5, environment 500 may include hosts 102-102n (referred to herein as host(s) 102), and storage devices 104a-104n (referred to herein as storage device(s) 104).

Storage device 104 may include a controller 108 to manage the resources on storage device 104. Controller 108 may include a host interface module 112 that may read data from and/or write to memory device 110 based on instructions received from host 102. Host interface module 112 may avoid reading descriptor content associated with a command index that has been flagged as an error command index, allowing host interface module 112 to quickly process descriptors with command indexes that have been flagged for errors. Host interface module 112 may also avoid reading descriptor content associated with a command index for a command associated with abort instructions. Hosts 102 and storage devices 104 may communicate via Non-Volatile Memory Express (NVMe) over peripheral component interconnect express (PCI Express or PCIe) standard, the Universal Flash Storage (UFS) over Unipro, or the like.

Devices of environment 500 may interconnect via wired connections, wireless connections, or a combination of wired and wireless connections. For example, the network of FIG. 5 may include a cellular network (e.g., a long-term evolution (LTE) network, a code division multiple access (CDMA) network, a 3G network, a 4G network, a 5G network, another type of next-generation network, and/or the like), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

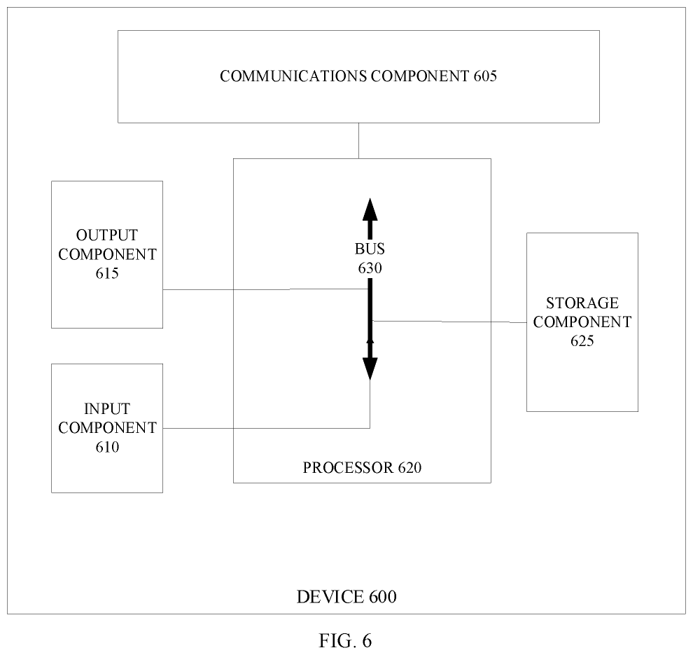

FIG. 6 is a diagram of example components of one or more devices of FIG. 1. In some implementations, host 102 may include one or more devices 600 and/or one or more components of device 600. Device 600 may include, for example, a communications component 605, an input component 610, an output component 615, a processor 620, a storage component 625, and a bus 630. Bus 630 may include components that enable communication among multiple components of device 600, wherein components of device 600 may be coupled to be in communication with other components of device 600 via bus 630.

Input component 610 may include components that permit device 600 to receive information via user input (e.g., keypad, a keyboard, a mouse, a pointing device, a microphone, and/or a display screen), and/or components that permit device 600 to determine the location or other sensor information (e.g., an accelerometer, a gyroscope, an actuator, another type of positional or environmental sensor). Output component 615 may include components that provide output information from device 600 (e.g., a speaker, display screen, and/or the like). Input component 610 and output component 615 may also be coupled to be in communication with processor 620.

Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 may include one or more processors capable of being programmed to perform a function. Processor 620 may be implemented in hardware, firmware, and/or a combination of hardware and software.

Storage component 625 may include one or more memory devices, such as random-access memory (RAM) 114, read-only memory (ROM), and/or another type of dynamic or static storage device (e.g., a flash memory, a magnetic memory, and/or optical memory) that stores information and/or instructions for use by processor 620. A memory device may include memory space within a single physical storage device or memory space spread across multiple physical storage devices. Storage component 625 may also store information and/or software related to the operation and use of device 600. For example, storage component 625 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, and/or another type of non-transitory computer-readable medium, along with a corresponding drive.

Communications component 605 may include a transceiver-like component that enables device 600 to communicate with other devices, such as via a wired connection, a wireless connection, or a combination of wired and wireless connections. The communications component 605 may permit device 600 to receive information from another device and/or provide information to another device. For example, communications component 605 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range. Communications component 605 may also include one or more broadband and/or narrowband transceivers and/or other similar types of wireless transceiver configurable to communicate via a wireless network for infrastructure communications. Communications component 605 may also include one or more local area network or personal area network transceivers, such as a Wi-Fi transceiver or a Bluetooth transceiver.

Device 600 may perform one or more processes described herein. For example, device 600 may perform these processes based on processor 620 executing software instructions stored by a non-transitory computer-readable medium, such as storage component 625. As used herein, the term “computer-readable medium” refers to a non-transitory memory device. Software instructions may be read into storage component 625 from another computer-readable medium or from another device via communications component 605. When executed, software instructions stored in storage component 625 may cause processor 620 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

We claim:

1. A storage device communicatively coupled to a host device that transmits commands to access data on the storage device, the storage device comprising:
a first memory device to store data; and
a host interface module to:
receive, from the host device, a command to access data on the first memory device;
generate one or more descriptors for the command, wherein the one or more descriptors include command information;
load a current descriptor for the command in a second memory device on the storage device and process the current descriptor; and
determine when the command information in the current descriptor is associated with a termination flag and prevent remaining descriptors associated with the command from being processed.

2. The storage device of claim 1, wherein in processing the current descriptor, the host interface module writes the current descriptor in the second memory and, using a descriptor index associated with the current descriptor, reads the current descriptor from the second memory.

3. The storage device of claim 1, wherein the current descriptor includes a descriptor index to identify a location in the second memory device where the current descriptor is stored and the command information to identify the command.

4. The storage device of claim 1, wherein the command information is a command index for the command.

5. The storage device of claim 1, wherein the host interface module prevents the remaining descriptors from being processed by preventing the remaining descriptors from being written in the second memory.

6. The storage device of claim 1, wherein the host interface module includes:
a host interface adapter to exchange information with the host device;
at least one accelerator to process the command and forward the command to a data transfer module; and
the data transfer module to generate the one or more descriptors for the command.

7. The storage device of claim 6, wherein the host interface adapter performs a primary check when the command is received from the host device, creates the command information, and sends the command to an accelerator for further processing.

8. The storage device of claim 6, wherein the data transfer module transmits a descriptor index for the current descriptor to the host interface adapter and loads the current descriptor in the second memory device.

9. The storage device of claim 6, wherein the host interface adapter generates an error message when the command information in the current descriptor is associated with the termination flag and transmits the error message to the data transfer module, wherein the data transfer module stops loading the remaining descriptors associated with the command in the second memory based on the error message.

10. The storage device of claim 6, wherein the host interface adapter is communicatively coupled to the data transfer module to receive and transmit information in queues.

11. The storage device of claim 6, wherein the host interface adapter generates a completed descriptor for a completed transaction and transmits a completed descriptor index for the completed descriptor to the data transfer module.

12. The storage device of claim 1, wherein the host interface module determines one of that the command information is associated with the termination flag when an error occurs while processing the current descriptor in the second memory device and if the command is an abort command received from the host.

13. A method to manage descriptor reads during command processing in a storage device communicatively coupled to a host device, the storage device having a first memory to store data and a processor to process commands received from the host device, the method comprises:
receiving, by the storage device from the host device, a command to access data on the first memory device;
generating, by the storage device, one or more descriptors for the command, wherein the one or more descriptors include command information;
loading, by the storage device, a current descriptor for the command in a second memory device on the storage device;
processing, by the storage device, the current descriptor,
determining, by the storage device, when the command information in the current descriptor is associated with a termination flag; and
preventing, by the storage device, remaining descriptors associated with the command from being processed.

14. The method of claim 13, wherein processing the current descriptor comprises writing the current descriptor in the second memory and, using a descriptor index associated with the current descriptor, reading the current descriptor from the second memory.

15. The method of claim 13, wherein preventing the processing of the remaining descriptors comprises preventing the remaining descriptors from being written in the second memory.

16. A storage device to manage descriptor reads during command processing, wherein the storage device is communicatively coupled to a host device, the storage device comprising:
a first memory to store data;
a host interface adapter to exchange information with the host device and receive a command from the host device; and
a data transfer module to generate one or more descriptors for the command and load a current descriptor for the command in a second memory device on the storage device, wherein the one or more descriptors include command information,
wherein the host interface adapter reads and processes the current descriptor in the second memory device and if the host interface adapter determines that the current descriptor is associated with a termination flag and the data transfer module stops writing remaining descriptors associated with the command in the second memory device.

17. The storage device of claim 16, wherein the host interface adapter generates an error message when the command information in the current descriptor is associated with the termination flag and transmits the error message to the data transfer module, wherein the data transfer module stops loading the remaining descriptors associated with the command based on the error message.

18. The storage device of claim 16, wherein the host interface adapter determines one of that the command information is associated with the termination flag when an error occurs while processing the current descriptor and if the command is an abort command received from the host.

19. The storage device of claim 16, wherein the host interface adapter is communicatively coupled to the data transfer module to receive and transmit information in queues.

20. The storage device of claim 16, wherein the host interface adapter generates a completed descriptor for a completed transaction and transmits a completed descriptor index for the completed descriptor to the data transfer module.
